(19) United States
(12) Patent Application Publication
(10) Pub. No.: US 2024/0338025 A1
(43) Pub. Date: Oct. 10, 2024

(54) SYSTEMS AND METHODS FOR AUTOMATED BIT IMAGING AND INSPECTION USING DRONES

(71) Applicant: Baker Hughes Oilfield Operations LLC, Houston, TX (US)

(72) Inventors: Eliah Everhard, The Woodlands, TX (US); William A. Moss, JR., Conroe, TX (US); John Abhishek Raj Bomidi, Peral River, NY (US); Saravanan Hiriaraman, The Woodlands, TX (US)

(21) Appl. No.: 18/295,734

(22) Filed: Apr. 4, 2023

(51) Int. Cl. G05D 1/10; B64U 10/14; E21B 41/00; G06T 7/00; G06T 7/70; H04N 23/695

(52) U.S. Cl. CPC G05D 1/101; B64U 10/14; E21B 41/00; G06T 7/0002; G06T 7/70; H04N 23/695; B64U 2101/26; B64U 2101/30; G06T 2207/10032; G06T 2207/30204

(57) ABSTRACT

Methods and systems for inspecting a drill bit are disclosed. The methods may include deploying a drone comprising a camera in proximity of a drill bit and instructing the drone to travel to a plurality of waypoints relative to the drill bit. The methods may also include capturing, using the camera, one or more images of the drill bit from the plurality of waypoints, and determining a state of the drill bit responsive to the captured images.

### TECHNICAL FIELD

This disclosure generally relates to wellbore drill bit inspection and using autonomous drones to perform drill bit inspections.

### BACKGROUND

Wellbores are formed in subterranean formations for various purposes including, for example, the extraction of oil and gas from a subterranean formation and the extraction of geothermal heat from a subterranean formation. A wellbore may be formed in a subterranean formation using a drill bit, such as, an earth-boring rotary drill bit. Different types of earth-boring rotary drill bits are known in the art, including, for example, fixed-cutter bits, drag bits, rolling-cutter bits (which may be referred to as “rock” bits), impregnated bits (impregnated with diamonds or other superabrasive particles), and hybrid bits (which may include, for example, both fixed cutters and rolling cutters).

As a drill bit is pulled from a wellbore hole, its physical appearance is inspected and graded according to the wear it has sustained in a standardized process called “bit dull grading.” The evaluation of drill bits is useful to help improve bit type selection according to the type of subterranean formations that are to be drilled, to know when to replace a drill bit because its useful life has been exhausted, and to improve future bit designs and performance.

### BRIEF SUMMARY

Methods and systems for inspecting a drill bit are disclosed. A method may include deploying a drone comprising a camera in proximity of a drill bit and instructing the drone to travel to a plurality of waypoints relative to the drill bit. A method may also include capturing, using the camera, one or more images of the drill bit from the plurality of waypoints, and determining a state of the drill bit responsive to the captured images.

One or more systems of the present disclosure may include a drone comprising a camera, wherein the drone is configured to capture images using the camera of a drill bit from a plurality of waypoints. The one or more systems may further include a computing device configured to receive the captured images from the drone and determine a state of the drill bit responsive to the captured images.

The methods and systems of the present disclosure also include a non-transitory computer-readable medium storing instructions thereon that, when executed by at least one processor, cause the at least one processor to perform various steps. The steps performed may include establishing a wireless connection with a drone and instructing the drone via the wireless connection to travel to a plurality of waypoints and capture one or more images of a drill bit at each of the plurality of waypoints. The steps performed by the processor further include receiving the captured images from the drone, and determining an overall damage level of the drill bit responsive to the captured images.

### BRIEF DESCRIPTION OF THE SEVERAL VIEWS OF THE DRAWINGS

FIG. 1 is a diagram of an environment in which a drone is deployed to capture images of a drill bit for analysis, according to one or more embodiments of the present disclosure.

FIG. 2 is a flow chart depicting a method of determining a state of a drill bit responsive to images captured by a drone, in accordance with one or more embodiments.

FIG. 3A is a side view of a drill bit depicting various example waypoints from which a drone may capture images of the drill bit.

FIG. 3B is a perspective view of a drill bit depicting example waypoints from which a drone may capture images of the drill bit.

FIG. 3C is a top view of a drill bit depicting example waypoints from which a drone may capture images of the drill bit.

FIG. 4 is a block diagram of circuitry that, in some embodiments, may be used to implement various functions, operations, acts, processes, and/or methods disclosed herein.

### DETAILED DESCRIPTION

In the following detailed description, reference is made to the accompanying drawings, which form a part hereof, and in which are shown, by way of illustration, specific examples of embodiments in which the present disclosure may be practiced. These embodiments are described in sufficient detail to enable a person of ordinary skill in the art to practice the present disclosure. However, other embodiments enabled herein may be utilized, and structural, material, and process changes may be made without departing from the scope of the disclosure.

The illustrations presented herein are not meant to be actual views of any particular method, system, device, or structure, but are merely idealized representations that are employed to describe the embodiments of the present disclosure. In some instances, similar structures or components in the various drawings may retain the same or similar numbering for the convenience of the reader; however, the similarity in numbering does not necessarily mean that the structures or components are identical in size, composition, configuration, or any other property.

The following description may include examples to help enable one of ordinary skill in the art to practice the disclosed embodiments. The use of the terms “exemplary.” “by example.” and “for example,” means that the related description is explanatory, and though the scope of the disclosure is intended to encompass the examples and legal equivalents, the use of such terms is not intended to limit the scope of an embodiment or this disclosure to the specified components, steps, features, functions, or the like.

It will be readily understood that the components of the embodiments as generally described herein and illustrated in the drawings could be arranged and designed in a wide variety of different configurations. Thus, the following description of various embodiments is not intended to limit the scope of the present disclosure, but is merely representative of various embodiments. While the various aspects of the embodiments may be presented in the drawings, the drawings are not necessarily drawn to scale unless specifically indicated.

The various illustrative logical blocks, modules, and circuits described in connection with the embodiments disclosed herein may be implemented or performed with a general purpose processor, a special purpose processor, a digital signal processor (DSP), an Integrated Circuit (IC), an Application Specific Integrated Circuit (ASIC), a Field Programmable Gate Array (FPGA) or other programmable logic device, discrete gate or transistor logic, discrete hardware components, or any combination thereof designed to perform the functions described herein. A general-purpose processor (may also be referred to herein as a host processor or simply a host) may be a microprocessor, but in the alternative, the processor may be any conventional processor, controller, microcontroller, or state machine. A processor may also be implemented as a combination of computing devices, such as a combination of a DSP and a microprocessor, a plurality of microprocessors, one or more microprocessors in conjunction with a DSP core, or any other such configuration. A general-purpose computer including a processor is considered a special-purpose computer while the general-purpose computer is configured to execute computing instructions (e.g., software code) related to embodiments of the present disclosure.

The embodiments may be described in terms of a process that is depicted as a flowchart, a flow diagram, a structure diagram, or a block diagram. Although a flowchart may describe operational acts as a sequential process, many of these acts may be performed in another sequence, in parallel, or substantially concurrently. In addition, the order of the acts may be re-arranged. A process may correspond to a method, a thread, a function, a procedure, a subroutine, a subprogram, other structure, or combinations thereof. Furthermore, the methods disclosed herein may be implemented in hardware, software, or both. If implemented in software, the functions may be stored or transmitted as one or more instructions or code on computer-readable media. Computer-readable media includes both computer storage media and communication media including any medium that facilitates transfer of a computer program from one place to another.

Any reference to an element herein using a designation such as “first.” “second,” and so forth does not limit the quantity or order of those elements, unless such limitation is explicitly stated. Rather, these designations may be used herein as a convenient method of distinguishing between two or more elements or instances of an element. Thus, a reference to first and second elements does not mean that only two elements may be employed there or that the first element must precede the second element in some manner. In addition, unless stated otherwise, a set of elements may include one or more elements.

As used herein, the term “substantially” in reference to a given parameter, property, or condition means and includes to a degree that one of ordinary skill in the art would understand that the given parameter, property, or condition is met with a small degree of variance, such as, for example, within acceptable manufacturing tolerances. By way of example, depending on the particular parameter, property, or condition that is substantially met, the parameter, property, or condition may be at least 90% met, at least 95% met, or even at least 99% met.

The term “state” of a drill bit refers to a condition or status of a drill bit. That is, the state of the drill bit can indicate a condition or status of the drill bit as compared to predetermined design or specification of the drill bit. Thus, the state of the drill bit can be based on a comparison of a condition of the drill bit to a design of a drill bit. For example, the state of the drill bit can indicate a condition of the drill bit that deviates from a predetermined design or specification, such as a comparison of an “as manufactured” drill bit to an “as-designed” drill bit. For example, the state of the drill bit can comprise a comparison of an angular orientation of one or more individual cutters as compared to a design or specification. In another example, the state of the drill bit can indicate an amount of wear or degradation that the drill bit experiences as a result of use. For example, the state of the drill bit can indicate a level of damage or wear of a drill bit and/or its component parts, including, for example, cutters, blades, and nozzles. The state of a drill bit may also include bit dull grading for individual cutters or teeth of the drill bit. In some cases, the level of damage or wear may be used to determine a useful remaining life of the drill bit and its component parts.

The term “as-designed” refers to a design or specification, such as a design or specification for a drill bit. An as-designed drill bit thus refers to the design or specification of the drill bit, which can be defined by engineering specifications including drawings, three-dimensional models (including computer-aided design (“CAD”) models), or the like.

The term “as-manufactured” refers to a built or manufactured product, such as a manufactured drill bit. An as-manufactured drill bit can be a built drill bit that is manufactured according to a specification and that can be compared to the specification (i.e., compared to the as-designed drill bit).

In this disclosure, any reference to an “individual cutter” of a fixed-cutter drill bit may also be understood to refer to an “individual tooth” or an individual “cutting insert” of a roller-cutter drill bit.

One example standardized process for bit inspection and dull grading has been created by the International Association of Drilling Contractors (IADC). Conventional methods for drill bit inspection, such as IADC bit dull grading, involve a trained technician performing a careful inspection of the drill bit and each individual cutter on the drill bit. The trained technician may assign scores representing the amount of wear on each cutter or tooth and indicate characteristics of any damage to the cutter, tooth, or other bit component. The standardized IADC process performed by an individual may be time-consuming, with a comprehensive dull grading process taking more than thirty minutes for a single drill bit. Furthermore, technicians performing the inspection may not be objective in the assessment or interpretation of the damage and wear. Images captured during the inspection are not centralized and may not be utilized by technicians in other locations to improve the consistency of inspection and grading.

Automated systems may exist for scanning drill bits and determining a dull grading score but such systems are generally large, heavy and sophisticated. These bulky machines may be expensive and difficult to own, operate, maintain, deploy, and relocate. It may not be feasible to transfer the drill bit scanning machinery to a field location where the drill bit is being utilized. It also may not be cost-effective to take drill bits out of use and transport them to a shop location where they may be reliably scanned and inspected.

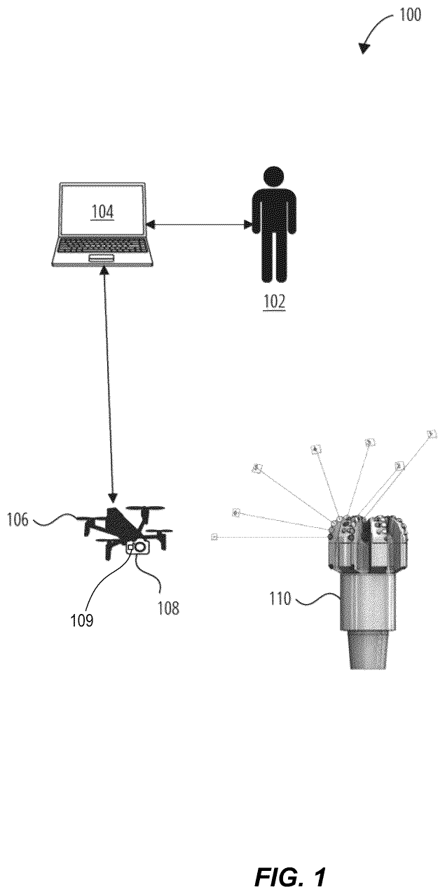

FIG. 1 is a diagram of an environment 100 in which a drone is deployed to capture images of a drill bit for analysis, according to one or more embodiments of the present disclosure. As illustrated, the environment 100 may include a user 102, computing device 104, drone 106, and drill bit 110.

In some embodiments, the user 102 may interface with the computing device 104 to set up and control the drone 106. The user 102 may be an individual (i.e., human user) and may be physically present where the drone is deployed or may be at a remote location. In some instances, the user 102 may be a technician that is trained to inspect drill bits to determine wear, dull grading, and remaining useful life of the drill bit. If at a remote location, the user 102 may connect to the computing device 104 via a network (i.e., the Internet, not shown).

The computing device 104 may be any one or more of various types of computing devices. For example, the computing device 104 may be a mobile device such as a mobile telephone, a smartphone, a PDA, a tablet, a laptop, or a non-mobile device such as a desktop computer or any other kind of computing device. The computing device 104 may be a dedicated drone controller. The computing device 104 may include a touchscreen, keyboard, joystick, or other means of receiving input from the user 102. The computing device 104 may also include a display and/or speakers to generate output messages for the user 102. The computing device 104 may initiate and/or receive a request to establish a wireless connection with the drone 106 and may establish and maintain a wireless connection with the drone 106. The computing device 104 may include an application that is programmed for wireless control of the drone 106. The computing device 104 may receive images captured by the drone 106 and may analyze the received images to determine a state of the drill bit based on the analysis of the captured images. In some embodiments, the user 102 may interface with the computing device 104 to set up the drone 106 and give instructions via the computing device 104 for the drone 106 to travel (i.e., fly) to different waypoints in succession to capture images of the drill bit at each of the different waypoints. In some embodiments, the user 102 manually controls the flight path of the drone 106 using the computing device 104. The computing device 104 may be connected to a remote server (not shown) which may perform some or all of analysis for determining a state of the drill bit 110. It should be noted that while a single computing device 104 is shown in FIG. 1, the computing device 104 can be a plurality of computing devices including one or more of the devices discussed above. For example, the computing device 104 can comprise several interconnected computing devices or computing systems.

The drone 106 may be, in some embodiments, a quadcopter with four rotors, and may also be referred to as an unmanned aerial vehicle (UAV) or an unmanned aircraft. Of course, the drone 106 can be any other suitable UAV having different numbers of rotors, and thus the quadcopter shown in FIG. 1 is merely exemplary. The drone can also be a fixed wing UAV. While a single drone 106 is shown in FIG. 1, it should be understood that more than one drone can be utilized in the environment. Thus, when referring to the drone 106, it should be understood that one drone 106, two drones 106, or more than two drones 106 could be utilized.

The drone 106 may include a camera 108, one or more processors, a wireless transceiver, a gyroscope (e.g., a gyrometer), an accelerometer, a GPS system, and a lidar imaging system. The camera 108 may be capable of capturing high-resolution images (i.e., photographs) and/or videos. The camera 108 may be separately controlled and may have its own axes of rotation such that the camera 108 may turn independently of the drone 106. The camera 108 may include a telescopic lens that may zoom in on particular elements of the drill bit 110.

The drone 106 may further include a light source 109. The light source 109 may be integrated with the camera 108 so as to point in the same direction as the camera 108. In other examples, the light source 109 may be mounted or otherwise attached to the drone 106 separate from the camera 108. The light source 109 may be any suitable light source such as an LED, inductions, fluorescent, halogen, or incandescent light source or the like. The light source may be attached to a fixture that can reflect and/or point the light in a certain direction, such as to direct the light towards the drill bit 110 or to particular elements of the drill bit 110. When the light source 109 is separate from the camera 108, the light source can be attached to the drone by way of a pointing mechanism such as a gimbal such that the light can be pointed independently from the drone 106.

In some examples where multiple drones 106 are used, one drone 106 may comprise the camera 108 while another drone 106 may comprise the light source 109. Thus, the drone with the light source 109 may illuminate at least a portion of the drill bit 110 while the drone 106 with the camera 108 may obtain images of at least a portion of the drill bit 110. In some examples, certain features or states of the drill bit 110 cannot easily be imaged without illumination from the light source 109. Thus, the light source 109 may provide illumination to the drill bit 110 or to particular elements of the drill bit 110 to facilitate imaging by the camera 108. In some examples, the light source 109 can comprise an infrared light source, a visible spectrum light source, or an ultraviolet light source depending upon the portion of the drill bit 110 to be imaged, or depending upon a state of the drill bit to be determined by the imaging. Similarly, the camera 108 can comprise one or more sensors operable in the infrared, visible, and/or ultraviolet spectrums.

The one or more processors may control the rotors on the drone such that the drone's location and flight path may be determined and/or executed. In some embodiments, the location and the flight path of the drone 106 is automatically calculated by the one or more processors of the drone 106 or the computing device 104 without substantial human intervention. In some embodiments, a user (e.g., user 102) manually controls the location and flight path of the drone 106 using a controller that may include one or more joysticks. The drone 106 may be capable of hovering for a period of time in substantially a same location such that one or more images may be captured from the location. Each location where the drone 106 hovers (i.e., in order to capture an image) is referred to herein as a waypoint. The wireless transceiver of the drone 106 may be used for wireless communication with computing device 104. The drone 106 may wirelessly receive instructions from the computing device 104 to travel to particular locations in space, and in some embodiments, to particular waypoints that are positioned relative to the drill bit 110. The drone 106 may be configured to capture multiple images of single elements of the drill bit 110 from different waypoints such that multiple images of the same element are captured from different angles.

The drone 106 may be configured to orient itself relative to the drill bit 110 responsive to positional markers placed on the drill bit 110. By way of example, the user 102 may place markers on particular points (i.e., cutters) of the drill bit 110, where each marker displays a particular pattern, color, number, or code. The pattern, color, number, or code may be scanned by the camera 108 and/or the lidar imaging system of the drone 106. The scanned image data (i.e., images from the camera 108 and/or lidar scan data) may be transmitted to the computing device 104 which may process the scanned image data for marker recognition. Upon recognition of the markers, the location and orientation of the drone 106 may be determined relative to the drill bit 110. In some embodiments, the computing device 104 includes engineering design data, such as a computer-aided design (CAD) file. The computing device 104 may use the engineering design data to compare the images captured by the drone 106 such that an orientation of the drone 106 relative to the drill bit 110 may be determined. In some cases, the engineering design data may include the markers on particular points of the CAD drawing of the drill bit which may be compared to the markers on the physical drill bit 110.

The drone 106 can also orient itself relative to the drill bit 110 using lidar scanning. For example, the drone 106 can comprise a lidar imaging system and can utilize the system to scan at least a portion of the drill bit 110. The generated lidar scan can be utilized to generate a three-dimensional model of at least a portion of the drill bit 110. The generated three-dimensional model can be compared to an as-designed drill bit. By comparing the three-dimensional model to the as-designed drill bit, features of the scanned drill bit 110 can be recognized, and the drone 106 can be oriented relative to the recognized features.

In another example, the drone 106 can orient itself relative to the drill bit 110 using computer vision. For example, the drone can obtain images of the drill bit via the camera 108. The drone 106 can send the images to the computing device 104 or to an onboard computer. The images can be scanned to recognize one or more features in the images that correspond with an as-design drill bit. The drone 106 can be oriented relative to the recognized features.

The drill bit 110 may be an earth-boring downhole drill bit for use in forming boreholes in subterranean formations, such as wellbores. The drill bit 110 may be a fixed-cutter drill bit (e.g., a polycrystalline diamond compact (PDC) bit, an impregnated bit such as a diamond bit, or a hybrid bit), a rolling-cutter bit (e.g., a roller-cone bit, a tri-cone bit, a milled-tooth bit, or a tungsten carbide insert bit). In some examples, the drill bit 110 may include several elements such as, for example, fixed cutting elements such as PDC cutters, rolling cutting elements such as milled teeth, blades, and nozzles.

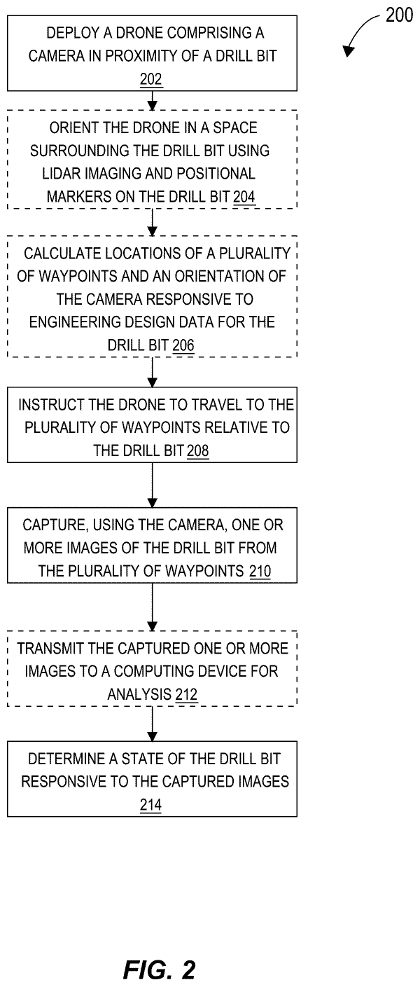

FIG. 2 is a flow chart depicting a method 200 of determining a state of a drill bit responsive to images captured by a drone, in accordance with one or more embodiments. At operation 202, a drone (i.e., drone 106 of FIG. 1) comprising a camera may be deployed in proximity of a drill bit. In some embodiments, a user (i.e., user 102 of FIG. 1) sets up the drone for operation and deploys the drone (i.e., turns on the drone and places it on the ground or a surface) within a few feet of the drill bit to be inspected. The user may ensure that the drill bit is isolated within a cubic space of approximately 36 inches in each direction. The user may also ensure that the area and conditions are appropriate for operation of the drone and that enough light is present for proper imaging of the drill bit. When deploying the drone, the user may orient the drone such that the camera of drone faces the drill bit.

At optional operation 204, the drone is oriented within a space surrounding the drill bit. For example, the drone can be oriented within the space using lidar imaging of the drill bit, positional markers on the drill bit, and/or by using computer aided vision. In some embodiments, the drone includes a lidar imaging system to scan the drill bit and generate a 3-dimensional map of the drill bit that may be used for orientation of the drone.

At optional operation 206, locations of a plurality of waypoints are calculated based on engineering design data for the drill bit. In some embodiments, the orientation of the drone and its camera, light source, or lidar imaging system is determined based in part on the engineering design data. A user may input basic bit details (e.g., drill bit identifying information including serial number, part number, bit type, bit brand, etc.) into a computing device (e.g., computing device 104 of FIG. 1) which may then retrieve the engineering design data from a centralized database. The locations of waypoints in relation to particular drill bits may be stored in the centralized database and may be accessed upon the input of the drill bit identifying information.

In some instances, the 3-dimensional map generated using the lidar imaging system is compared to the engineering design data to determine the orientation of the drone in relation to the drill bit. The locations of the plurality of waypoints may be calculated to be perpendicular (i.e., normal) to a face of respective individual cutters of the drill bit. The locations of the plurality of waypoints may also be determined to be a predetermined distance from the faces of the respective individual cutters that are to be imaged. In one or more embodiments, the distance between the face of the individual cutters of the drill bit and the drone camera may be predetermined to be 24 inches, or may be any distance ranging from 12 to 30 inches. The waypoints including the distance of the drone and the camera relative to the drill bit can also be based on the camera or the lidar imaging system. For example, the distance can vary based on a focal length of the camera or the like.

In some instances, the locations of the plurality of waypoints can be determined to provide a scan of a portion of the drill bit or to provide a scan of the entire drill bit. For example, the waypoints can comprise positions on a single side of the drill bit or within predetermined elevation and circumferential angles relative to the drill bit for a partial bit scan. In another example, the waypoints can comprise positions around the entire drill bit for a full bit scan. In some examples, the waypoints can comprise positions at regular intervals about the drill bit (e.g., in 5-degree elevational increments and 5-degree circumferential increments relative to the drill bit). In other examples, the waypoints can comprise positions relative to particular features or part of particular features of the drill bit (e.g., for conducting a full or partial blade scan). In some examples where a drone with a light source and a drone with a camera are used, a first set of waypoints can be determined for the drone with the light source to illuminate predetermined features of the drill bit, and a second set of waypoints can be determined for the drone with the camera to image the predetermined features of the drill bit.

In operation 208 of method 200, the drone is instructed to travel to the plurality of waypoints relative to the drill bit. The drone may receive instructions from a computing device (i.e., computing device 104 of FIG. 1) that is in wireless communication with the drone. In some embodiments, a 3-dimensional map of the space surrounding the drill bit may also be generated. The drone may then receive instructions to travel to particular coordinates based on the 3-D map of the space surrounding the drill bit. The drone or its connected controlling computing device may include application programming interfaces (APIs) or software development kits (SDKs) that allow translating a set of programmed waypoint commands or task commands to instructions for the drone to travel to particular points in space.

In operation 210 of method 200, one or more images may be captured using the camera of the drill bit from the plurality of waypoints. In one or more embodiments, the one or more images may also be captured using the lidar imaging system. In some examples, capturing the one or more images can also comprise illuminating at least a portion of the drill bit with the light source while capturing the images. An image of the drill bit may include an image of a component or element of the drill bit, including for example, individual cutters, blades, or nozzles. In some instances, each waypoint corresponds to an individual cutter, where each waypoint is calculated specifically such that an image of an individual cutter may be captured from the corresponding waypoint. In other embodiments, multiple images of an individual cutter may be captured from multiple waypoints of the plurality of waypoints, such that multiple images of an individual cutter may be captured from different locations and angles. The plurality of waypoints may also be calculated such that images of the entire bit from different angles may be captured.

In operation 212 of method 200, the captured images may be transmitted to the computing device for analysis. The images may be transferred in any suitable manner, such as via a wired or wireless connection with the computing device via any suitable communication protocol. In operation 214 of method 200, a state of the drill bit is determined responsive to the captured images. In some instances, the state of the drill bit may be determined by the computing device that received and analyzed the captured images. The captured images may be transmitted to a centralized database or server for storage and/or analysis and any analysis indicated as performed by the computing device in the present disclosure may be performed by a remote server.

In some embodiments, analyzing the captured images to determine the state of the drill bit (operation 214) includes comparing the captured images to other images depicting an as-designed drill bit. In one or more embodiments, the captured images can include captured lidar scans. The captured images including the lidar scans may be compared to a design or specification of the drill bit such as engineering design data depicting the as-designed drill bit. Such engineering design data can comprise a three-dimensional model such as a computer-aided design (CAD) three-dimensional model. Determining the state of the drill bit can include comparing an as-manufactured drill bit to an as-designed drill bit to determine whether any irregularities are present in a drill bit as compared to the design. Determining a state of the drill bit can also include assessing a level of damage of the drill bit or its component parts based on wear experienced by the drill bit over time. Determining the state of the drill bit may also include determining a remaining useful life of the drill bit and its component parts based on the damage level or any other deviations from the as-designed drill bit.

Determining the state of the drill bit may also include determining a state of individual elements including cutters or teeth of the drill bit. In one example, each individual cutter can receive a dull state and damage classification, or a dull grading score, based on the captured images. Determining a state of the drill bit can also include aggregating the dull grading score of each cutter or tooth to determine an overall drill bit grade or score of health. An overall drill bit score, health score, or damage level may be compared to a threshold score or damage level. If the scores or damage level exceeds the threshold score or damage level, the user may be informed that the drill bit is no longer viable and should be replaced. If the scores or damage levels are within a threshold of acceptability, a prompt may be generated for the user indicating what the overall damage level is for the drill bit and possible repairs that may be useful for the drill bit. If the scores or damage levels are within the threshold, a prompt may be generated for the user indicating a useful remaining life of the drill bit and its component parts. Furthermore, the damage level and health scores may be useful for the user to determine whether the drill bit type is appropriate for the conditions of the drilled wellbore.

In one or more embodiments, the results of the analysis at the computing device may be reviewed by a human user to evaluate the results for quality, accuracy, and acceptability of the drill bit state determination.

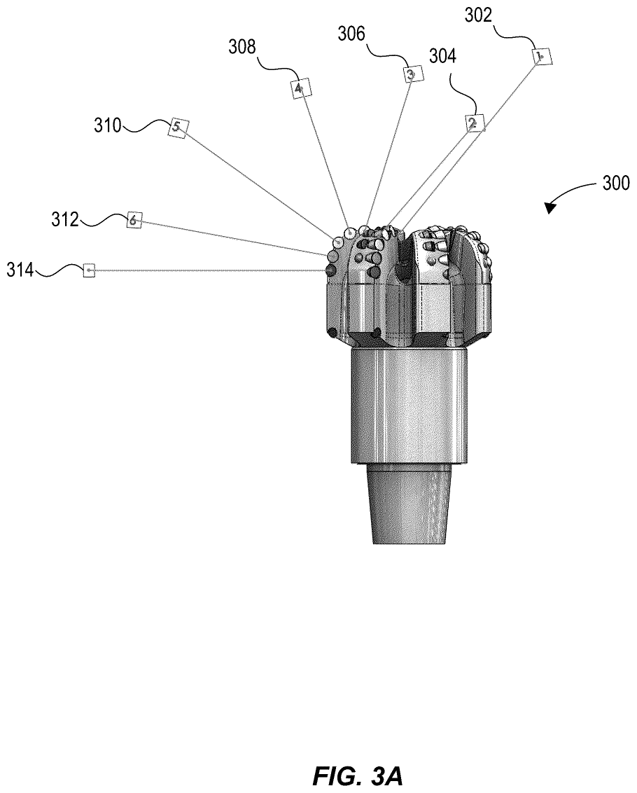

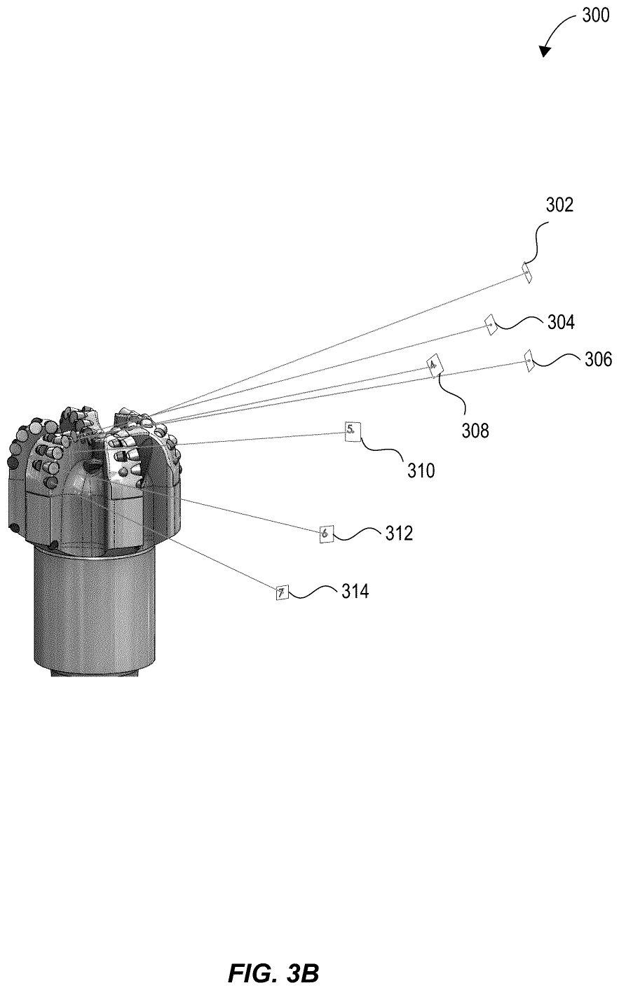

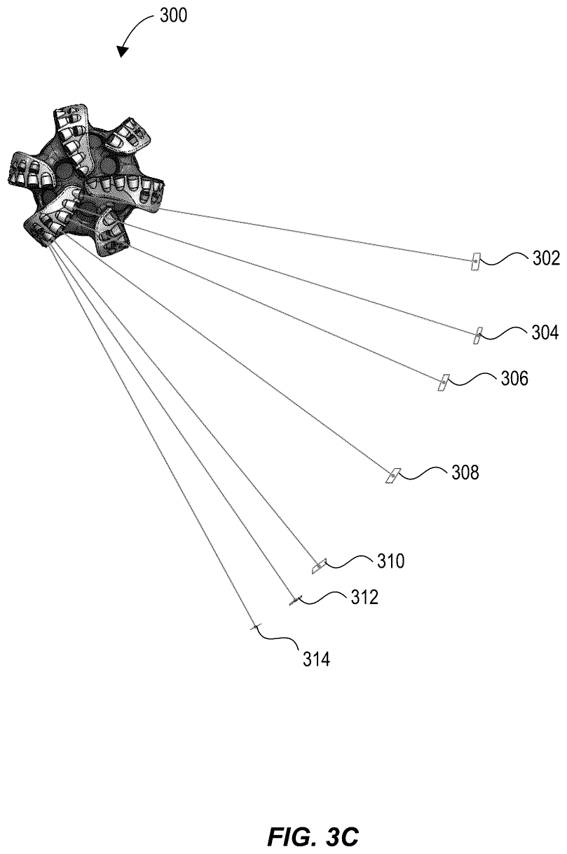

FIG. 3A is a side view of a drill bit 300 depicting various example waypoints 302-314 from which a drone may capture images of the drill bit. FIG. 3B is a perspective view and FIG. 3C is a top view of the drill bit 300 depicting the example waypoints from which a drone may capture images of the drill bit 300. The drill bit 300 may be an example of a drill bit 110 of FIG. 1. In FIGS. 3A-3C, the drill bit 300 is an example of a PDC drill bit. Example waypoints 302-314 are normal to, and 24 inches away from, the face of individual cutters on the drill bit 300.

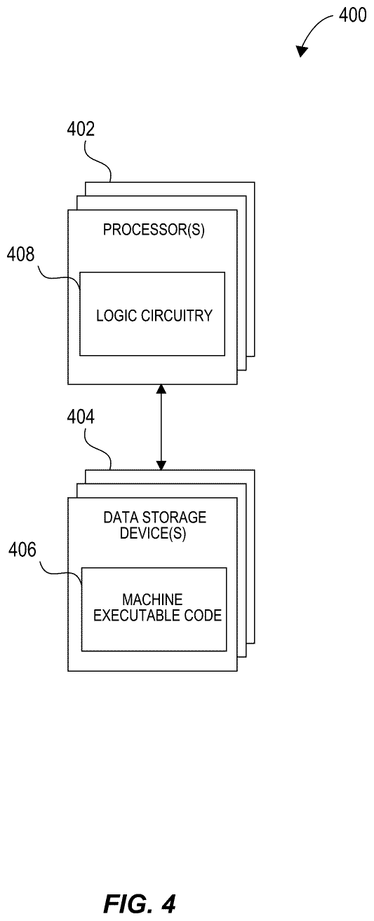

It will be appreciated by those of ordinary skill in the art that functional elements of embodiments disclosed herein (e.g., functions, operations, acts, processes, and/or methods) may be implemented in any suitable hardware, software, firmware, or combinations thereof. FIG. 4 illustrates non-limiting examples of implementations of functional elements disclosed herein. In some embodiments, some or all portions of the functional elements disclosed herein may be performed by hardware specially configured for carrying out the functional elements.

FIG. 4 is a block diagram of circuitry 400 that, in some embodiments, may be used to implement various functions, operations, acts, processes, and/or methods disclosed herein. The circuitry 400 includes one or more processors 402 (sometimes referred to herein as “processors 402”) operably coupled to one or more data storage devices (sometimes referred to herein as “storage 404”). The storage 404 includes machine executable code 406 stored thereon and the processors 402 include logic circuitry 408. The machine executable code 406 includes information describing functional elements that may be implemented by (e.g., performed by) the logic circuitry 408. The logic circuitry 408 is adapted to implement (e.g., perform) the functional elements described by the machine executable code 406. The circuitry 400, when executing the functional elements described by the machine executable code 406, should be considered as special purpose hardware configured for carrying out functional elements disclosed herein. In some embodiments, the processors 402 may be configured to perform the functional elements described by the machine executable code 406 sequentially, concurrently (e.g., on one or more different hardware platforms), or in one or more parallel process streams.

When implemented by logic circuitry 408 of the processors 402, the machine executable code 406 is configured to adapt the processors 402 to perform operations of embodiments disclosed herein. For example, the machine executable code 406 may be configured to adapt the processors 402 to perform at least a portion or a totality of the method 200 of determining a state of a drill bit. As another example, machine executable code 406 may adapt processors 402 to perform at least a portion or a totality of the operations discussed for computing device 104 or drone 106 of FIG. 1.

The processors 402 may include a general purpose processor, a special purpose processor, a central processing unit (CPU), a microcontroller, a programmable logic controller (PLC), a digital signal processor (DSP), an application specific integrated circuit (ASIC), a field-programmable gate array (FPGA) or other programmable logic device, discrete gate or transistor logic, discrete hardware components, other programmable device, or any combination thereof designed to perform the functions disclosed herein. A general-purpose computer including a processor is considered a special-purpose computer while the general-purpose computer is configured to execute functional elements corresponding to the machine executable code 406 (e.g., software code, firmware code, hardware descriptions) related to embodiments of the present disclosure. It is noted that a general-purpose processor (may also be referred to herein as a host processor or simply a host) may be a microprocessor, but in the alternative, the processors 402 may include any conventional processor, controller, microcontroller, or state machine. The processors 402 may also be implemented as a combination of computing devices, such as a combination of a DSP and a microprocessor, a plurality of microprocessors, one or more microprocessors in conjunction with a DSP core, or any other such configuration.

In some embodiments, the storage 404 includes volatile data storage (e.g., random-access memory (RAM)), non-volatile data storage (e.g., Flash memory, a hard disc drive, a solid state drive, erasable programmable read-only memory (EPROM), etc.). In some embodiments, the processors 402 and the storage 404 may be implemented into a single device (e.g., a semiconductor device product, a system on chip (SOC), etc.). In some embodiments, the processors 402 and the storage 404 may be implemented into separate devices.

In some embodiments, the machine executable code 406 may include computer-readable instructions (e.g., software code, firmware code). By way of non-limiting example, the computer-readable instructions may be stored by the storage 404, accessed directly by the processors 402, and executed by the processors 402 using at least the logic circuitry 408. Also by way of non-limiting example, the computer-readable instructions may be stored on the storage 404, transferred to a memory device (not shown) for execution, and executed by the processors 402 using at least the logic circuitry 408. Accordingly, in some embodiments, the logic circuitry 408 includes electrically configurable logic circuitry 408.

In some embodiments, the machine executable code 406 may describe hardware (e.g., circuitry) to be implemented in the logic circuitry 408 to perform the functional elements. This hardware may be described at any of a variety of levels of abstraction, from low-level transistor layouts to high-level description languages. At a high-level of abstraction, a hardware description language (HDL) such as an IEEE Standard hardware description language (HDL) may be used. By way of non-limiting examples, VERILOG™, SYSTEMVERILOG™ or very large scale integration (VLSI) hardware description language (VHDL™) may be used.

HDL descriptions may be converted into descriptions at any of numerous other levels of abstraction as desired. As a non-limiting example, a high-level description can be converted to a logic-level description such as a register-transfer language (RTL), a gate-level (GL) description, a layout-level description, or a mask-level description. As a non-limiting example, micro-operations to be performed by hardware logic circuits (e.g., gates, flip-flops, registers, without limitation) of the logic circuitry 408 may be described in a RTL and then converted by a synthesis tool into a GL description, and the GL description may be converted by a placement and routing tool into a layout-level description that corresponds to a physical layout of an integrated circuit of a programmable logic device, discrete gate or transistor logic, discrete hardware components, or combinations thereof. Accordingly, in some embodiments, the machine executable code 406 may include an HDL, an RTL, a GL description, a mask level description, other hardware description, or any combination thereof.

In embodiments where the machine executable code 406 includes a hardware description (at any level of abstraction), a system (not shown, but including the storage 404) may be configured to implement the hardware description described by the machine executable code 406. By way of non-limiting example, the processors 402 may include a programmable logic device (e.g., an FPGA or a PLC) and the logic circuitry 408 may be electrically controlled to implement circuitry corresponding to the hardware description into the logic circuitry 408. Also by way of non-limiting example, the logic circuitry 408 may include hard-wired logic manufactured by a manufacturing system (not shown, but including the storage 404) according to the hardware description of the machine executable code 406.

Regardless of whether the machine executable code 406 includes computer-readable instructions or a hardware description, the logic circuitry 408 is adapted to perform the functional elements described by the machine executable code 406 when implementing the functional elements of the machine executable code 406. It is noted that although a hardware description may not directly describe functional elements, a hardware description indirectly describes functional elements that the hardware elements described by the hardware description are capable of performing.

As used in the present disclosure, the terms “module” or “component” may refer to specific hardware implementations configured to perform the actions of the module or component and/or software objects or software routines that may be stored on and/or executed by general purpose hardware (e.g., computer-readable media, processing devices, etc.) of the computing system. In some embodiments, the different components, modules, engines, and services described in the present disclosure may be implemented as objects or processes that execute on the computing system (e.g., as separate threads). While some of the system and methods described in the present disclosure are generally described as being implemented in software (stored on and/or executed by general purpose hardware), specific hardware implementations or a combination of software and specific hardware implementations are also possible and contemplated.

As used in the present disclosure, the term “combination” with reference to a plurality of elements may include a combination of all the elements or any of various different subcombinations of some of the elements. For example, the phrase “A, B, C, D, or combinations thereof” may refer to any one of A, B, C, or D; the combination of each of A, B, C, and D; and any subcombination of A, B, C, or D such as A, B, and C; A, B, and D; A, C, and D; B, C, and D; A and B; A and C; A and D; B and C; B and D; or C and D.

Terms used in the present disclosure and especially in the appended claims (e.g., bodies of the appended claims) are generally intended as “open” terms (e.g., the term “including” should be interpreted as “including, but not limited to,” the term “having” should be interpreted as “having at least,” the term “includes” should be interpreted as “includes, but is not limited to,” etc.).

Additionally, if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations.

In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” or “one or more of A, B, and C, etc.” is used, in general such a construction is intended to include A alone, B alone, C alone, A and B together, A and C together, B and C together, or A, B, and C together, etc.

Further, any disjunctive word or phrase presenting two or more alternative terms, whether in the description, claims, or drawings, should be understood to contemplate the possibilities of including one of the terms, either of the terms, or both terms. For example, the phrase “A or B” should be understood to include the possibilities of “A” or “B” or “A and B.”

While the present disclosure has been described herein with respect to certain illustrated embodiments, those of ordinary skill in the art will recognize and appreciate that the present disclosure is not so limited. Rather, many additions, deletions, and modifications to the illustrated and described embodiments may be made without departing from the scope of the disclosure as hereinafter claimed along with their legal equivalents. In addition, features from one embodiment may be combined with features of another embodiment while still being encompassed within the scope of the disclosure as contemplated by the inventor.

What is claimed is:

1. A method of inspecting a drill bit, comprising:
deploying a drone in proximity of a drill bit, the drone comprising a camera;
instructing the drone to travel to a plurality of waypoints relative to the drill bit;
capturing, using the camera, one or more images of the drill bit from the plurality of waypoints; and
determining a state of the drill bit responsive to the captured images.

2. The method of claim 1, wherein capturing, using the camera, one or more images from the plurality of waypoints comprises capturing a respective image of an individual cutter of the drill bit at each of the respective plurality of waypoints, each of the plurality of the waypoints corresponding to a respective individual cutter.

3. The method of claim 1, wherein capturing, using the camera, one or more images from the plurality of waypoints comprises capturing multiple images of an individual cutter of the drill bit from multiple waypoints of the plurality of waypoints.

4. The method of claim 1, further comprising orienting the drone in a space surrounding the drill bit using one or more of lidar imaging, positional markers, and computer vision on the drill bit.

5. The method of claim 1, further comprising calculating locations of the plurality of waypoints and an orientation of the camera responsive to engineering design data for the drill bit.

6. The method of claim 1, further comprising:
transmitting the captured one or more images to a computing device; and
analyzing, at the computing device, the captured one or more images to determine the state of the drill bit.

7. The method of claim 6, wherein analyzing the captured images to determine the state of the drill bit comprises comparing the captured images to images depicting an as-designed drill bit.

8. The method of claim 1, wherein each of the plurality of waypoints is located perpendicular to a respective cutter face of the drill bit.

9. The method of claim 1, wherein each of the plurality of waypoints is located at regular intervals about the drill bit.

10. A system, comprising:
a drone comprising a camera, the drone configured to capture images using the camera of a drill bit from a plurality of waypoints; and
a computing device configured to:
receive the captured images from the drone; and
determine a state of the drill bit responsive to the captured images.

11. The system of claim 10, wherein the drone is further configured to orient itself relative to the drill bit responsive to positional markers placed on the drill bit.

12. The system of claim 10, wherein the drone further comprises a lidar imaging system and is further configured to:
use the lidar imaging system to scan the drill bit; and
orient itself relative to the drill bit responsive to the lidar imaging scan.

13. The system of claim 12, wherein the drone is further configured to orient itself relative to the drill bit based on engineering design data.

14. The system of claim 10, wherein the drone is further configured to capture images using the camera of the drill bit by capturing multiple images of an individual element of the drill bit from different waypoints of the plurality of waypoints.

15. The system of claim 10, wherein the drone is a quadcopter.

16. The system of claim 10, wherein the computing device is configured to:
establish a wireless connection with the drone;
instruct the drone via the wireless connection to travel to the plurality of waypoints in succession; and
capture one or more images of the drill bit at each of the plurality of waypoints.

17. A non-transitory computer-readable medium storing instructions thereon that, when executed by at least one processor, cause the at least one processor to perform steps comprising:
establishing a wireless connection with a drone;
instructing the drone via the wireless connection to travel to a plurality of waypoints and capture one or more images of a drill bit at each of the plurality of waypoints;
receiving the captured images from the drone; and
determining a state of the drill bit responsive to the captured images.

18. The non-transitory computer-readable medium of claim 17, wherein determining the state of the drill bit further comprises:
determining that an overall damage level exceeds a threshold damage level; and
informing a user that the drill bit should be replaced.

19. The non-transitory computer-readable medium of claim 17, wherein determining the state of the drill bit further comprises:
determining that an overall damage level is within a threshold damage level; and
generating a prompt for a user indicating the overall damage level of the drill bit and possible repairs for the drill bit.

20. The non-transitory computer-readable medium of claim 17, wherein determining the state of the drill bit comprises determining a damage level for one or more individual cutters, blades, and nozzles of the drill bit.
